(19) United States
(12) Patent Application Publication
(10) Pub. No.: US 2006/0285595 A1
(43) Pub. Date: Dec. 21, 2006

(54) Intermediate vector interpolation method and three-dimensional (3D) display apparatus performing the method

(75) Inventors: Tae-hyeun Ha, Suwon-si (KR); Jae-seok Kim, Seoul (KR); Ji-yong Park, Seoul (KR); Won-jae Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/432,468

(22) Filed: May 12, 2006

(30) Foreign Application Priority Data
Jun. 21, 2005 (KR) 10-2005-0053594

(51) Int. Cl. H04N 11/02; H04N 7/12; H04N 11/04; H04B 1/66

(52) U.S. Cl. 375/240.16; 375/240.24

(57) ABSTRACT

A method of generating an intermediate image between a first frame and a second frame, using the first frame and a third frame successively received from a first camera and the second frame and a fourth frame successively received from a second camera. The intermediate image generating method includes: calculating and summing pixel value differences between the first frame and the third frame in units of a block; determining whether or not a center pixel of a block has motion; calculating current disparity vectors corresponding to motion vectors between the first frame and the second frame, and calculating previous disparity vectors corresponding to motion vectors between the third frame and the fourth frame; and generating the intermediate image using the current disparity vectors if the center pixel of the block has motion, and calculating an intermediate value of the previous disparity vectors and generating the intermediate image using the intermediate value of the previous disparity vectors if the center pixel of the block has no motion.

### CROSS-REFERENCE TO RELATED APPLICATIONS

This application claims priority from Korean Patent Application No. 10-2005-0053594, filed on Jun. 21, 2005, the entire content of which is incorporated herein by reference.

### BACKGROUND OF THE INVENTION

1. Field of the Invention

The present invention relates to a method of generating an intermediate image for pixels having no motion by using previous disparity vectors, instead of current disparity vectors, and a three-dimensional (3D) display apparatus performing the method.

2. Description of the Related Art

Recently, studies on three-dimensional (3D) video technologies including a multiview video coding method are actively being carried out in America, Europe, Japan, etc. Multiview 3D TVs allow viewers to view different 3D images according to their locations, thus providing more natural 3D images. However, providing different 3D images at all viewpoints is actually impossible, and, further, high costs result from transmission of a large amount of data for all viewpoints. Accordingly, intermediate vector interpolation of generating images for non-existing viewpoints using transmitted images is required.

The intermediate vector interpolation is disparity estimation of detecting similarity between two images and representing disparity between the two images as vectors. The disparity estimation is classified into a feature-based disparity estimation scheme of detecting and matching feature points of images, a dynamic programming disparity estimation scheme of detecting and matching a shortest path of a cost function, and an area-based disparity estimation scheme of estimating and matching correlation of windows.

However, when these disparity estimation methods are applied to moving images, a flicker phenomenon is generated near boundaries between objects. In the case of an unmoving object in an image, the same image must be displayed at a minimum 45 frames per every second. If the same image is not maintained during 45 frames per every second or if the same images are not displayed, viewers will experience blinks on the unmoving object. The blinks on the unmoving object are called flickers.

In the case of the intermediate vector interpolation on moving images, an unmoving object must be displayed with the same image for every frame while the object does not move. However, due to a small amount of shaking of a stereo camera or a change in lighting, etc., disparity vector estimation can be incorrectly performed. If a distorted intermediate viewpoint image frame is inserted due to such incorrect disparity vectors, viewers will perceive flickers when viewing the unmoving object on the moving image. Therefore, a method capable of preventing flickering, when an intermediate viewpoint image of a moving image is interpolated, is required.

### SUMMARY OF THE INVENTION

An aspect of the present invention is to provide an intermediate image generating method which is capable of preventing flickering, by applying disparity vectors of a current frame or disparity vectors of a previous frame to each image according to whether or not images received from at least two cameras have motion, to thus generate an intermediate image, and a three-dimensional (3D) display apparatus performing the method.

In order to achieve particular aspects of the present invention, there is provided a method of generating an intermediate image between a first frame and a second frame, using the first frame and a third frame successively received from a first camera and the second frame and a fourth frame successively received from a second camera, including: calculating and summing pixel value differences between the first frame and the third frame in units of a block; determining whether or not a center pixel of a block has motion on the basis of the summed result; calculating current disparity vectors corresponding to motion vectors between the first frame and the second frame, and calculating previous disparity vectors corresponding to motion vectors between the third frame and the fourth frame; and generating the intermediate image using the current disparity vectors if it is determined that the center pixel of the block has motion, and calculating an intermediate value of the previous disparity vectors and generating the intermediate image using the intermediate value of the previous disparity vectors if it is determined that the center pixel of the block has no motion.

The determination of whether or not the center pixel of the block has motion includes: comparing the sum of the pixel value differences with a first threshold value, to thus determine that a center pixel of a block in which a sum of pixel value differences is greater than the first threshold value is a first center pixel having motion and determine that a center pixel of a block in which a sum of pixel value differences is smaller than the first threshold value is a second center pixel having no motion; comparing the number of first center pixels or the number of second center pixels in a predetermined area of the first frame, with a second threshold value; and determining that a center pixel of the predetermined area is the first center pixel having motion if the sum of the pixel value differences is greater than the second threshold value, and determining that the center pixel of the predetermined area is the second center pixel having no motion if the number of the first center pixels or the number of the second center pixels is smaller than the second threshold value.

Also, the operation of comparing the sum of the pixel value differences with the first threshold value may be performed by calculating and summing pixel value differences between the second frame and the fourth frame in units of a block and comparing the summed result with the first threshold value.

In order to achieve another aspect of the present invention, there is provided a three-dimensional (3D) display apparatus of generating an intermediate image between a first frame and a second frame, using the first frame and a third frame successively received from a first camera and the second frame and a fourth frame successively received from a second camera, including: a first calculator calculating and summing pixel value differences between the first frame and the third frame in units of a block, and then comparing the summed result with a first threshold value; a motion determining unit determining that a center pixel of a block in which a sum of pixel value differences is greater than the first threshold value is a first center pixel having motion, and determining that a center pixel of a block in which a sum of pixel value differences is smaller than the first threshold value is a second center pixel having no motion; a disparity vector calculator calculating current disparity vectors corresponding to motion vectors between the first frame and the second frame, and calculating previous disparity vectors corresponding to motion vectors between the third frame and the fourth frame; and an intermediate image generator generating the intermediate image using the current disparity vectors if it is determined that the center pixel of the block has motion, and calculating an intermediate value of the previous disparity vectors and generating the intermediate image using the intermediate value of the previous display vectors if it is determined that the center pixel of the block has no motion.

The 3D display apparatus may further include: a second calculator comparing the number of first center pixels or the number of second center pixels in a predetermined area of the first frame, with a second threshold value.

If a sum of pixel value differences in a certain area of the first frame calculated by the second calculator is greater than the second threshold value, the motion determining unit determines that a center pixel of the predetermined area is the first center pixel having motion, and if the number of the first center pixels or the number of the second center pixels is smaller than the second threshold value, the motion determining unit determines that the center pixel of the predetermined area is the second center pixel having no motion.

The first calculator calculates and sums pixel value differences between the first frame and the third frame in units of a block, and compares the summed result with the first threshold value.

### BRIEF DESCRIPTION OF THE DRAWINGS

The above aspects of the present invention will be more apparent by describing exemplary embodiments of the present invention with reference to the accompanying drawings, in which:

FIG. 1 is a block diagram of a thee-dimensional (3D) display apparatus performing an intermediate image generating method, according to an exemplary embodiment of the present invention;

FIG. 2 is a flowchart illustrating an intermediate image generating method according to an exemplary embodiment of the present invention;

FIG. 3 is a view for explaining the intermediate image generating method of FIG. 2 in detail;

FIG. 4 is a view for explaining a method of determining whether or not a pixel has motion in respective frames, according to the intermediate image generating method of FIG. 2; and

FIG. 5 is a view for explaining a method of estimating disparity vectors according to the intermediate image generating method of FIG. 2.

### DETAILED DESCRIPTION OF EXEMPLARY EMBODIMENTS

Exemplary embodiments of the present invention will be described in greater detail with reference to the accompanying drawings.

Hereinafter, an operation in which an intermediate image corresponding to an intermediate viewpoint of a first camera and a second camera is generated using a first frame and a second frame respectively captured by the first camera and the second camera which are separated from each other by a predetermined distance, will be described as an example.

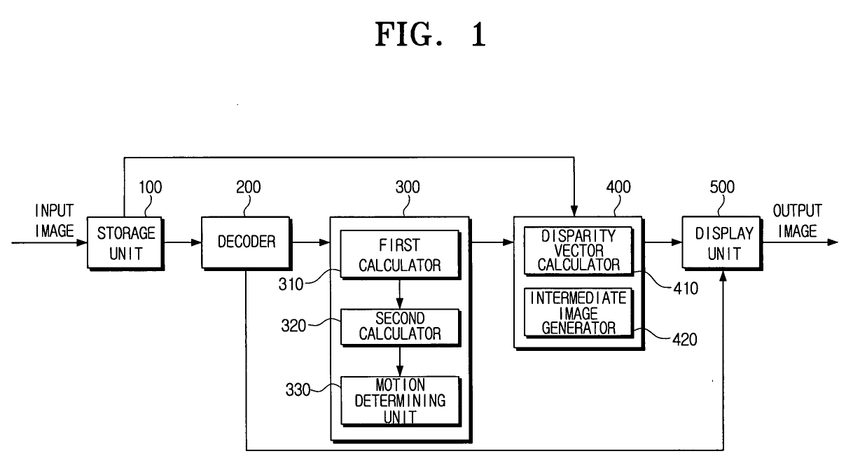

FIG. 1 is a block diagram of a three-dimensional (3D) display apparatus performing an intermediate image generating method, according to an exemplary embodiment of the present invention.

Referring to FIG. 1, the 3D display apparatus includes a storage unit 100, a decoder 200, a determining unit 300, a generator 400, and a display unit 500.

The storage unit 100 stores temporally successive input images in units of a frame. In detail, the storage unit 100 sequentially stores a first fame, a third frame, a fifth frame, etc. which are images captured by a first camera, and sequentially stores a second frame, a fourth frame, a sixth frame, etc. which are images captured by a second camera.

Here, the first frame is a current frame captured by the first camera, the third frame is received before the first frame is received, and the fifth frame is received before the third frame is received.

Also, the second frame is a current frame captured by the second camera, the fourth frame is received before the second frame is received, and the sixth frame is received before the fourth frame is received. Accordingly, the first and second frames, the third and fourth frames, and the fifth and sixth frames are respectively images captured by the first camera and the second camera at the same time.

The decoder 200 decodes encoded input images.

The determining unit 300 includes a first calculator 310, a second calculator 320, and a motion determining unit 330, and determines whether or not the first and second frames as current frames have motion with respect to the previous frames, using the pixel value differences between the current frames and the previous frames, in units of a pixel. That is, the determining unit 300 determines whether or not a pixel of the current frame has motion, using a pixel value difference between the first frame and the third frame or using a pixel value difference between the second frame and the fourth frame. Hereinafter, a case of determining whether or not motion exists using a pixel value difference between the first frame and the third frame, will be described as an example.

In detail, the first calculator 310 of the determining unit 300 calculates the pixel value differences between the first frame and the third frame in units of a block and sums the calculation results, and then compares the summed result with a first threshold value.

The second calculator 320 compares the number of center pixels of blocks in each of which a sum of pixel value differences is greater than the first threshold value in a predetermined area of the first frame, or the number of center pixels of blocks in each of which a sum of pixel value differences is smaller than the first threshold value in a predetermined area of the first frame, with a second threshold value.

In a case where a center pixel value of a block of the first frame is decided to be “1” if a sum of pixel value differences in the block is greater than the first threshold value, and a center pixel value of a block of the first frame is decided to be “0” if a sum of pixel value differences in the block is smaller than the first threshold value, the number of the center pixels of blocks in each of which a sum of pixel value differences is greater than the first threshold value is compared with the second threshold value.

On the contrary, in a case where a center pixel value of a block of the first frame is decided to be “0” if a sum of pixel value differences in the block is greater than the first threshold value, and a center pixel value of a block of the first frame is decided to be “1” if a sum of pixel value differences in the block is smaller than the first threshold value, the number of center pixels of blocks in each of which a sum of pixel value differences is smaller than the first threshold value is compared with the second threshold value.

That is, after pixels of a predetermined area of the first frame are decided to be “1” or “0”, the decided values are summed and the summed result is compared with the second threshold value.

If the second calculator 320 determines that the sum is greater than the second threshold value, the motion determining unit 330 determines that a center pixel of the predetermined area has motion. If the second calculator 320 determines that the sum is smaller than the second threshold value, the motion determining unit 330 determines that a center pixel of the predetermined area has no motion.

Accordingly, if the first calculator 310 determines that a center pixel of a block has motion and a plurality of pixels having motion exist in a predetermined area, the motion determining unit 330 determines that a center pixel of the predetermined area corresponding to the center pixel of the block has motion. Meanwhile, if it is determined that a center pixel of a block has no motion and a plurality of pixels having no motion exist in a predetermined area, the motion determining unit 330 determines that a center pixel of the predetermined area corresponding to the center pixel of the block has no motion.

Meanwhile, the motion determining unit 330 can determine whether or not respective pixels of the first frame have motion, only using the result from the first calculator 310. The first calculator 310 determines that the center pixel of a block in which a sum of pixel value differences is greater than the first threshold value has motion, and determines that the center pixel of a block in which a sum of pixel value differences is smaller than the first threshold value has no motion. However, by using the result from the second calculator 320, it is possible to more accurately determine whether or not the center pixels of blocks have motion.

The generator 400 includes a disparity vector calculator 410 and an intermediate image generator 420. The generator 400 generates an intermediate image between the first frame and the second frame using current disparity vectors or previous disparity vectors, according to the determination result of the determining unit 300.

That is, the disparity vector calculator 410 calculates the current disparity vectors which are disparity vectors between the first frame and the second frame corresponding to current frames, and calculates the previous disparity vectors which are disparity vectors between the third frame and the fourth frame corresponding to previous frames. Here, the disparity vectors are used to estimate a difference between images for the same object captured at the same time by a first camera and a second camera, according to the locations of the cameras, wherein the disparity vectors are calculated in units of a block.

If the determining unit 300 determines that pixels of the first frame have motion, the intermediate image generator 420 generates an intermediate image using the current disparity vectors. If the determining unit 300 determines that pixels of the first frame have no motion, the intermediate image generator 420 generates an intermediate image using the previous disparity vectors. That is, each pixel value of the intermediate image between the first frame and the second frame is decided to an intermediate value of the current disparity vectors or to an intermediate value of the previous disparity vectors, according to whether or not the first frame has motion.

Accordingly, by generating an intermediate image for pixels having motion using previous disparity vectors, without generating the intermediate image using current disparity vectors, it is possible to prevent flickering resulting from changes in brightness values.

The display unit 500 displays the images captured by the first and second cameras, and the intermediate image corresponding to an intermediate viewpoint of the first and second cameras, created using the images.

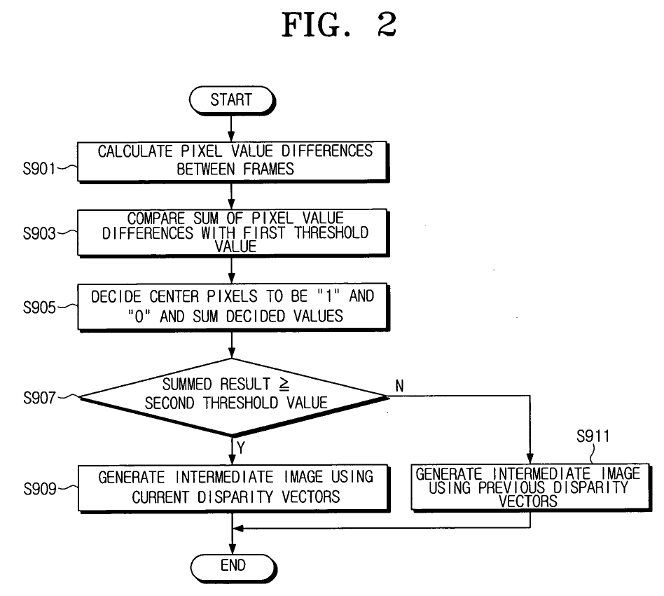

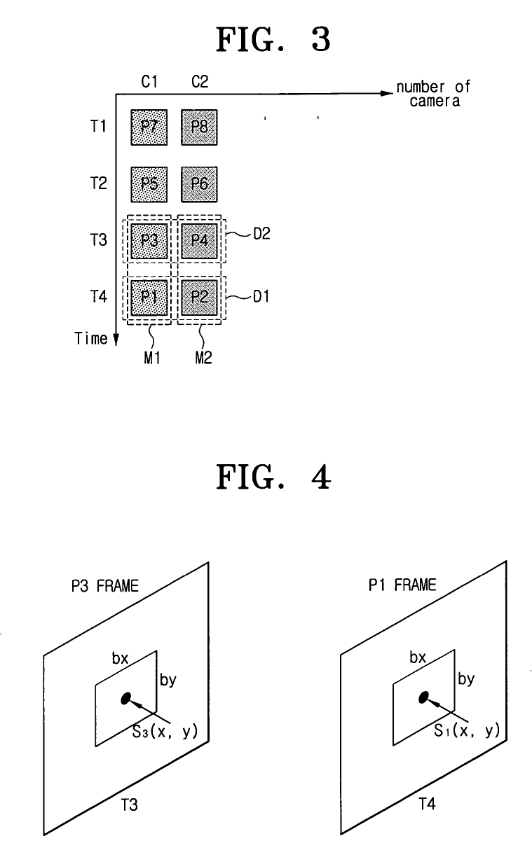

FIG. 2 is a flowchart illustrating an intermediate image generating method according to an exemplary embodiment of the present invention. FIG. 3 is a view for explaining the intermediate image generating method of FIG. 2 in detail.

Referring to FIG. 3, the intermediate image generating method is used to generate an intermediate image corresponding to an intermediate viewpoint of a first camera C1 and a second camera C2 adjacent to each other, using images captured at the same time by the first camera C1 and the second camera C2. In FIG. 3, the horizontal axis represents a camera number and the vertical axis represent time. Accordingly, frames P1, P3, P5 and P7 are successively captured by the first camera C1, and frames P2, P4, P6 and P8 are successively captured by the second camera C2.

Hereinafter, a method of generating an intermediate image of the frames P1 and P2 respectively captured at a time T4 by the first camera C1 and the second camera C2 will be described as an example. In order to generate the intermediate image, the frame P3 captured by the first camera C1 before the frame P1 is captured, and the frame P4 captured by the second camera C2 before the frame P2 is captured, are used.

Referring to FIG. 2, first, pixel value differences between the first frame P1 and the third frame P3 are calculated (operation S901). The images captured by the first and second cameras C1 and C2 are stored in units of a frame, and the pixel value differences between the first frame P1 and the third frame P3 successively received from the first camera C1 are calculated. Calculating the pixel value differences is performed to determine whether or not each pixel of the first frame P1 has motion. Alternately, by calculating pixel value differences between the second frame P2 and the fourth frame P4 successively received from the second camera C2 disposed at a location different from the first camera C1, it can be determined whether or not motion exists.

Successively, the pixel value differences of the first frame P1 calculated in units of a block are summed and the summed result is compared with a first threshold value (operation S903).

FIG. 4 is a view for explaining a method of determining whether or not a pixel has motion in respective frames, according to the intermediate image generating method of FIG. 2. Referring to FIG. 4, in order to determine whether or not a center pixel S1 of a first frame P1 received at a time T4 has motion with respect to a pixel S3 disposed at the corresponding location of a third frame P3 received at a time T3, respective pixel value differences between a block having a horizontal length bx and a vertical length by centering on the center pixel S1, and a block having a horizontal length bx and a vertical length by centering on the center pixel S3, are summed. Accordingly, the sum of the pixel value differences can be expressed by the following equation 1.

$$CV ( x , y ) = {\sum }_{i = x \cdot bx / 2}^{x + bx / 2} {\sum }_{j = y \cdot by / 2}^{y + by / 2} \vert {I}_{P 3 ( i , j )} - {I}_{P 1} ( x , y ) \vert \qquad ( 1 )$$

Where, CV represents a sum of pixel value differences of a block of the first frame P1, P1 and P3 respectively represent the first frame and the third frame, and I_{P1} and I_{P3} respectively represent the brightness of the first frame P1 and the brightness of the third frame P3. Also, bx and by respectively represent the horizontal and vertical lengths of a block in each of the first and third frames P1 and P3 and (x, y) represents the location of a center pixel of each block.

Then, the sum of the pixel value differences between the frames P1 and P3, calculated in units of a block, is compared with a first threshold value. Here, the first threshold value is experimentally decided on the basis of the size of an image and a degree of motion in the image.

Successively, in a predetermined area of the first frame P1, a center pixel of a block in which a sum of pixel value differences is greater than the first threshold value, and a center pixel of a block in which a sum of pixel value differences is smaller than the first threshold value, are respectively decided to be “1” and “0”, and then the decided values in the predetermined area are summed (operation S905). In this exemplary embodiment, in a predetermined area of the first frame P1, a center pixel value (a first center pixel value) of a block in which a sum of pixel value differences is greater than the first threshold value is decided to be “1”, and a center pixel value (a second center pixel value) of a block in which a sum of pixel value differences is smaller than the first threshold value is decided to be “0”. Accordingly, the first and second center pixel values can be expressed by the following equation 2.
CM(x,y)=1,CV>Th1
CM(x,y)=0,CV<Th1 (2)

Where, CM represents a center pixel of a block of the first frame P1, and (x, y) represents the location of the center pixel. Also, CV represents a sum of pixel value differences between the first frame P1 and the third frame P3 and Th1 represents the first threshold value.

Successively, the values “1” and “0” assigned to the respective pixels in the predetermined area are summed and the summed value is compared with a second threshold value (operation S907). The summed value can be calculated by the following equation 3.

$$SCM ( x , y ) = {\sum }_{i = x \cdot h / 2}^{x + w / 2} {\sum }_{j = y \cdot h / 2}^{y + w / 2} CM ( i , j ) \qquad ( 3 )$$

Where, SCM is a center pixel value assigned to each pixel in a predetermined area of the first frame P1, and (x, y) represents the location of the pixel in the predetermined area. Also, CM is a center pixel of a block, which may be the first center pixel or the second center pixel, as expressed by equation 2. Also, h and w respectively represent the horizontal and vertical lengths of the predetermined area.

As expressed in equation 3, the first center pixel values and the second center pixel values assigned to pixels in a predetermined area are summed. The summed value is compared with the second threshold value, thereby determining whether or not a center pixel of the predetermined area has motion.

Alternately, using equation 2, it is possible to determine that a center pixel of a block has motion if a sum of pixel value differences of the block is greater than the first threshold value, and to determine that a center pixel of a block has no motion if a sum of pixel value differences of the block is smaller than the first threshold value. However, due to noise, etc. of the center pixel, a second center pixel having no motion may be determined as a first center pixel having motion. If an intermediate image is generated according to such wrong determination, a flickering phenomenon can be caused by the generated intermediate image.

Accordingly, instead of determining whether or not the respective pixels of the first frame have motion using only a sum of the pixel value differences of each block, a predetermined area is set centering on a center pixel of a block decided by equation 2. Then, values “1” and “0” assigned to respective pixels in the predetermined area using equation 2 are summed. If the summed value (the number of pixels having motion to which the value “1” is assigned) is greater than the second threshold value, it is determined that a center pixel of the predetermined area has motion. That is, if a center pixel of a block has motion and the number of pixels having motion in the predetermined area is greater than the second threshold value, it is determined that a center pixel of the predetermined area has motion.

Successively, if the sum of the values “1” and “0” assigned to the respective pixels in the predetermined area is greater than the second threshold value, an intermediate image is generated using current disparity vectors (operation S909). The case where the sum of the respective pixel values (“1” and “0”) in the predetermined area is greater than the second threshold value, corresponds to the case where the number of pixels in which a sum of pixel difference values in the predetermined area exceeds the first threshold value is greater than the second threshold value. In this case, it can be determined that a center pixel of the predetermined area has motion. Accordingly, after disparity vectors between a first frame and a second frame which are current frames are estimated, an intermediate image between the first frame and the second frame is generated using the current disparity vectors. Therefore, the intermediate image between the first frame and the second frame is generated by deciding pixel values of the intermediate image using an intermediate value of the current disparity vectors.

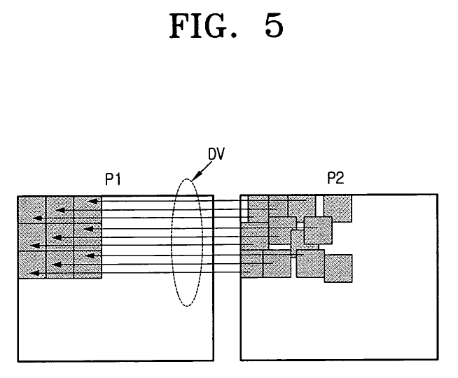

Meanwhile, the estimation of the disparity vector is performed by estimating a difference between images for the same object respectively captured at the same time by the first camera and the second camera, according to the locations of a first camera and a second camera. FIG. 5 is a view for explaining a method of estimating the disparity vectors according to the intermediate image generating method of FIG. 2. Referring to FIG. 5, disparity vectors DV between a first frame P1 and a second frame P2 are estimated in units of a block. Here, the size of a block is preferably 16×16, and may be 8×8 or below according to the characteristic of an image.

Meanwhile, if a sum of values “1” and “0” assigned to respective pixels in a predetermined area is smaller than the second threshold value, an intermediate image is generated using previous disparity vectors (operation S911). The case where the sum of the respective pixel values (“1” and “0”) in the predetermined area is smaller than the second threshold value, corresponds to the case where the number of pixels in which a sum of pixel difference values in the predetermined area exceeds the first threshold value is smaller than the second threshold value. In this case, it can be determined that a center pixel of the predetermined area has no motion.

Accordingly, if it is determined that the center pixel of the predetermined area has no motion, an intermediate image between the first frame and the second frame is generated using previous disparity vectors. Here, the previous disparity vectors are disparity vectors between the third frame which is the previous image of the first frame, and the fourth frame which is the previous image of the second frame. The previous disparity vectors have been described above with reference to FIG. 5.

Then, an intermediate value of the previous disparity vectors is decided to be pixel values of the intermediate image, so that an intermediate image between the first frame and the second frame is generated. At this time, if it is determined that pixels of the first frame have no motion with respect to the third frame which is the previous frame of the first frame, the intermediate image is generated using the previous disparity vectors generated using the third frame being the previous frame, instead of using the current disparity vectors generated using the first frame.

Meanwhile, if correct motion information can be received from a compressed moving image based on a MPEG standard, etc., the intermediate image can be generated based on the received motion information according to operations S909 and S911, instead of determining whether or not pixels have motion according to operations S901 through S907.

In the above exemplary embodiment, a method of generating an intermediate image in a stereo-view display apparatus which displays images captured by two cameras has been described, however, the method can be also applied to a multi-view display apparatus which displays images captured by a plurality of cameras which are separated from each other with a predetermined distance and successively disposed.

As described above, according to exemplary embodiments of the present invention, by applying previous disparity vectors estimated using a previous frame to pixels having no motion when an intermediate image is generated from images received from at least two cameras, it is possible to prevent flickering resulting from changes in brightness values of an unmoving object in a moving image.

The foregoing embodiments are merely exemplary and are not to be construed as limiting the present invention. The present teaching can be readily applied to other types of exemplary embodiments. Also, the description of the exemplary embodiments of the present invention is intended to be illustrative, and not to limit the scope of the claims, and many alternatives, modifications, and variations will be apparent to those skilled in the art.

What is claimed is:

1. A method of generating an intermediate image between a first frame and a second frame by using the first frame and a third frame successively received from a first camera and by using the second frame and a fourth frame successively received from a second camera, comprising:
calculating and summing pixel value differences between the first frame and the third frame in units of a block;
determining whether or not a center pixel of a block has a motion, on the basis of the summed result;
calculating current disparity vectors corresponding to motion vectors between the first frame and the second frame, and calculating previous disparity vectors corresponding to motion vectors between the third frame and the fourth frame; and
generating the intermediate image using the current disparity vectors if it is determined that the center pixel of the block has a motion, and calculating an intermediate value of the previous disparity vectors and generating the intermediate image by calculating the intermediate value of the previous disparity vectors if it is determined that the center pixel of the block has no motion.

2. The method of claim 1, wherein the determining comprises:
comparing the sum of the pixel value differences with a first threshold value and determining a center pixel of a block in which a sum of pixel value differences is greater than the first threshold value as a first center pixel having motion and determining a center pixel of a block in which a sum of pixel value differences is smaller than the first threshold value as a second center pixel having no motion;
comparing the number of first center pixels or the number of second center pixels in a predetermined area of the first frame, with a second threshold value; and
determining that a center pixel of the predetermined area is the first center pixel having motion if the sum of the pixel value differences is greater than the second threshold value, and determining that the center pixel of the predetermined area is the second center pixel having no motion if the number of the first center pixels or the number of the second center pixels is smaller than the second threshold value.

3. The method of claim 2, wherein said comparing the sum of the pixel value differences with the first threshold value is performed by calculating and summing pixel value differences between the second frame and the fourth frame in units of a block and comparing the summed result with the first threshold value.

4. A three-dimensional display apparatus which generates an intermediate image between a first frame and a second frame, using the first frame and a third frame successively received from a first camera and the second frame and a fourth frame successively received from a second camera, comprising:
a first calculator which calculates and sums pixel value differences between the first frame and the third frame in units of a block, and then compares the summed result with a first threshold value;
a motion determining unit which determines that a center pixel of a block in which a sum of pixel value differences is greater than the first threshold value is a first center pixel having motion, and determines that a center pixel of a block in which a sum of pixel value differences is smaller than the first threshold value is a second center pixel having no motion;
a disparity vector calculator which calculates current disparity vectors corresponding to motion vectors between the first frame and the second frame, and calculates previous disparity vectors corresponding to motion vectors between the third frame and the fourth frame; and
an intermediate image generator which generates the intermediate image using the current disparity vectors if it is determined that the center pixel of the block has a motion, and calculates an intermediate value of the previous disparity vectors and generates the intermediate image using the intermediate value of the previous disparity vectors if it is determined that the center pixel of the block has no motion.

5. The three-dimensional display apparatus of claim 4, further comprising:
a second calculator which compares the number of first center pixels or the number of second center pixels in a predetermined area of the first frame, with a second threshold value.

6. The three-dimensional display apparatus of claim 5, wherein if a sum of pixel value differences in a certain area of the first frame calculated by the second calculator is greater than the second threshold value, the motion determining unit determines that a center pixel of the predetermined area is the first center pixel having motion, and if the number of the first center pixels or the number of the second center pixels in the predetermined area is smaller than the second threshold value, the motion determining unit determines that the center pixel of the predetermined area is the second center pixel having no motion.

7. The three-dimensional display apparatus of claim 4, wherein the first calculator calculates and sums pixel value differences between the first frame and the third frame in units of a block, and compares the summed result with the first threshold value.
